(19) United States
(12) Patent Application Publication
(10) Pub. No.: US 2026/0252169 A1
(43) Pub. Date: Aug. 27, 2026

(54) EYE-TRACKING OPTICAL SYSTEM AND HEAD-MOUNTED DEVICE

(71) Applicant: BEIJING 7INVENSUN TECHNOLOGY CO., LTD., Beijing (CN)

(72) Inventors: Chihua MENG, Beijing (CN); Tongbing HUANG, Beijing (CN)

(73) Assignee: BEIJING 7INVENSUN TECHNOLOGY CO., LTD., Beijing (CN)

(21) Appl. No.: 18/878,034

(22) PCT Filed: Jun. 20, 2023
(86) PCT No.: PCT/CN2023/101522

§ 371 Date: Nov. 7, 2025

(30) Foreign Application Priority Data
Jun. 21, 2022 (CN) 202210705618.2

(51) Int. Cl. G06F 3/01; G02B 27/01; H04N 23/20; H04N 23/55; H04N 23/56

(52) U.S. Cl. CPC G06F 3/013; G02B 27/0179; H04N 23/20; H04N 23/55; H04N 23/56; G02B 2027/0187

(57) ABSTRACT

An eyeball tracking optical system and a head-mounted device is provided. The system includes a light source module, an eyepiece module, a first optical path adjustment module and an image collection module; the light source module is located on a side edge of the eyepiece module that is close to a user eyeball, and the light source module is configured to emit light ray of a preset wavelength to the user eyeball; the light ray of the preset wavelength is reflected by the user eyeball to form reflected light ray; the eyepiece module and the first optical path adjustment module are sequentially located on a side away from the user eyeball; the reflected light ray at least passes through the eyepiece module and then enters the image collection module.

### CROSS-REFERENCE TO RELATED APPLICATIONS

The present application is a National Stage Entry under 35 U.S.C. § 371 of PCT International Application No. PCT/CN 2023/101522, filed on Jun. 20, 2023, which claims the priority of Chinese Patent Application 202210705618.2, filed in the China Patent Office on Jun. 21, 2022, and entitled “ Eyeball Tracking Optical System and Head-Mounted Device ”, the entire contents of each of which are incorporated herein by reference for all purposes.

### TECHNICAL FIELD

The present disclosure relates to the technical field of eyeball tracking, and in particular to an eyeball tracking optical system and a head-mounted device.

### BACKGROUND

The eyeball tracking technology may be implemented by using an optical recording method. The principle of the optical recording method is to use an infrared camera to record eye movement situations of a testee, that is, to acquire an eye image capable of reflecting eye movements, and extract eye features from the acquired eye image so as to establish an estimation model of line of sight, wherein the eye features may include a pupil position, a pupil shape, an iris position, an iris shape, an eyelid position, a canthus position, a light spot position (or a Purkinje image), and the like. The optical recording method includes a pupil-cornea reflection method. The principle of the pupil-cornea reflection method is that a near-infrared light source irradiates an eye, the infrared camera photographs the eye and phonographs a reflection point, that is, a light spot, of the light ray source on the cornea, so as to obtain an eye image with the light spot.

Since current virtual reality (VR) helmets tend to be developed and designed in the direction of being thin in thickness and foldable, most of the VR helmets are produced and developed based on compact display optical machines. FIG. 1 is a schematic structural diagram of an eyeball tracking optical system provided in the prior art. As shown in FIG. 1, in the prior art, a camera 4 is usually disposed on a side of a fixed lens 1 of an eyeball tracking optical system that is close to a user eye 5, an axial horizontal included angle a of a photosensitive surface of the camera is relatively large in the structural design, which directly affects the image quality, and thus the algorithm precision is limited.

### SUMMARY

The present disclosure provides an eyeball tracking optical system and a head-mounted device. By moving a camera device from an edge of a side of an eyepiece module that is close to a user eyeball to an edge of a side of the eyepiece module that is away from the user eyeball, that is, disposing same behind the eyepiece of the optical system, an axial horizontal included angle of a camera is reduced, an incident field angle of light is increased, and the algorithm precision of image collection and the image quality of the camera are improved.

The present disclosure provides an eyeball tracking optical system, including a light source module, an eyepiece module, a first optical path adjustment module and an image collection module, wherein
the light source module is located on an edge of a side, close to a user eyeball, of the eyepiece module, and the light source module is configured to emit light ray of a preset wavelength to the user eyeball; the light ray of the preset wavelength is reflected by the user eyeball to form reflected light ray;
the eyepiece module and the first optical path adjustment module are sequentially located on a side away from the user eyeball, and the image collection module is located on an edge of a side of a gap between the eyepiece module and the first optical path adjustment module; and
the reflected light ray at least passes through the eyepiece module and then enters the image collection module, and the image collection module is configured to generate an image of the user eyeball according to the received reflected light ray.

Optionally, a photosensitive surface of the image collection module faces the user eyeball, and the reflected light ray passes through the eyepiece module and then enters the image collection module.

Optionally, the eyeball tracking optical system further includes a dimming module; the dimming module and the image collection module are fixedly disposed; and
the dimming module is configured to adjust the propagation direction of the reflected light ray; and the reflected light ray passes through the eyepiece module and then enters the image collection module after being reflected by the dimming module.

Optionally, the dimming module includes a reflective prism, and
the reflected light ray is reflected by a reflective surface of the reflective prism and then enters the image collection module.

Optionally, the reflective surface of the reflective prism includes a reflection-enhancement film.

Optionally, the light source module includes an array infrared band light source, configured to emit light ray of an array infrared band.

Optionally, the dimming module includes an infrared cut-off sheet, configured to reflect the light ray of the array infrared band emitted from the array infrared band light source to the image collection module.

Optionally, the eyepiece module includes a first fixed lens, and the first optical path adjustment module includes a second fixed lens and an adjustable lens; and
an optical axis of the first fixed lens, an optical axis of the second fixed lens and an optical axis of the adjustable lens are located on the same straight line; and the adjustable lens may move in the direction of the straight line.

Optionally, the eyeball tracking optical system further includes a display screen; and
the display screen is located on a side, away from the user eyeball, of the first optical path adjustment module, and the display screen is a multi-dimensional display screen, configured to display a multi-dimensional image.

In a second aspect, the present disclosure further provides a head-mounted device, including a head-mounted apparatus and the above eyeball tracking optical system.

The eyeball tracking optical system provided in the present disclosure includes the light source module, the eyepiece module, the first optical path adjustment module and the image collection module; the light source module is located on the edge of the side, close to the user eyeball, of the eyepiece module, and the light source module is configured to emit the light ray of the preset wavelength to the user eyeball; the light ray of the preset wavelength is reflected by the user eyeball to form the reflected light ray; the eyepiece module and the first optical path adjustment module are sequentially located on the side away from the user eyeball, and the image collection module is moved from the edge of the side of the eyepiece module that is close to the user eyeball to the edge of the side of the eyepiece module that is away from the user eyeball, so that the image collection module is disposed inside the system; the reflected light ray at least passes through the eyepiece module and then enters the image collection module, so as to reduce the axial horizontal included angle of the photosensitive surface of a camera and to increase the incident field angle of the light ray; and the image collection module is configured to generate the image of the user eyeball according to the received reflected light ray. Therefore, by using the structural settings, the algorithm precision of image collection and the image quality of the camera can be improved.

### BRIEF DESCRIPTION OF THE DRAWINGS

FIG. 1 is a schematic structural diagram of an eyeball tracking optical system provided in the prior art;

FIG. 2 is a schematic structural diagram of an eyeball tracking optical system provided in the present disclosure;

FIG. 3 is a schematic structural diagram of another eyeball tracking optical system provided in the present disclosure;

FIG. 4 is a schematic structural diagram of a dimming module and an image collection module provided in the present disclosure; and

FIG. 5 is a schematic structural diagram of another dimming module and another image collection module provided in the present disclosure.

### DETAILED DESCRIPTION OF THE EMBODIMENTS

The present disclosure will be further described in detail below with reference to the drawings and embodiments. It can be understood that specific embodiments described herein are merely used for explaining the present disclosure, rather than limiting the present disclosure. In addition, it should be noted that for ease of description, only some, but not all, structures related to the present disclosure are shown in the drawings.

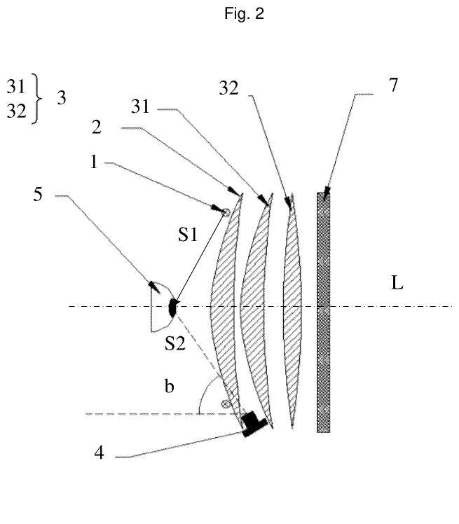

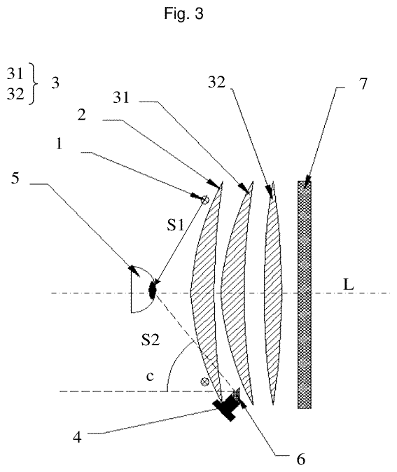

FIG. 2 is a schematic structural diagram of an eyeball tracking optical system provided in the present disclosure; and FIG. 3 is a schematic structural diagram of another eyeball tracking optical system provided in the present disclosure. As shown in FIG. 2 and FIG. 3, the eyeball tracking optical system provided in the present disclosure includes a light source module 1, an eyepiece module 2, a first optical path adjustment module 3 and an image collection module 4; the light source module 1 is located on an edge of a side, close to a user eyeball 5, of the eyepiece module 2, and the light source module 1 is configured to emit light ray S1 of a preset wavelength to the user eyeball 5; the light ray S1 of the preset wavelength is reflected by the user eyeball 5 to form reflected light ray S2; the eyepiece module 2 and the first optical path adjustment module 3 are sequentially located on a side away from the user eyeball 5, and the image collection module 4 is located on an edge of a side of a gap between the eyepiece module 2 and the first optical path adjustment module 3; and the reflected light ray S2 at least passes through the eyepiece module 2 and then enters the image collection module 4, and the image collection module 4 is configured to generate an image of the user eyeball 5 according to the received reflected light ray S2.

Specifically, as shown in FIG. 2 and FIG. 3, the eyeball tracking optical system provided in the present disclosure further includes a mounting frame (not shown in the figure), the light source module 1, the eyepiece module 2, the first optical path adjustment module 3 and the image collection module 4 may be fixedly disposed in the mounting frame, and the eyepiece module 2 may include at least one fixedly disposed lens, which protects other assemblies and focus light ray; the image collection module 4 includes at least one image collection device, such as a camera, which is configured to image imaging; and the light source module 1 includes at least one light-emitting light source, which may emit the light ray S1 of the preset wavelength acceptable to eyes, such as light ray of a visible light band and light ray of light ray of an infrared band. The light source module 1 is located on the edge of the side of the eyepiece module 2 that is close to the user eyeball 5, the image collection module 4 is located on the edge of the side of the gap between the eyepiece module 2 and the first optical path adjustment module 3, that is, located between the eyepiece module 2 and the first optical path adjustment module 3, a built-in camera is used for photographing, at this time, the axial horizontal included angle of a photosensitive surface of the camera is b or c, b<α, and c<α; by moving the image collection module 4 from the edge of the side of the eyepiece module 2 that is close to the user eyeball 5 to the edge of the side of the eyepiece module 2 that is away from the user eyeball 5, an external camera is used for photographing, so that the axial horizontal included angle of the photosensitive surface of the camera can be reduced, the incident field angle of the light ray is increased, and thus the algorithm precision of image collection and the image quality of the camera are improved; and the position of the camera may also be saved, and the volume of the eyeball tracking optical system is compressed, thereby meeting the structural design requirements of the eyeball tracking and iris recognition technology of a compact display optical machine. Specifically, when the eyeball tracking optical system works, the light ray emitted from the light source module 1 irradiates the user eyeball 5, a reflection point formed on the cornea of the user eyeball 5 is referred to as a light spot (also referred to as a Purkinje image), the light is reflected by the user eyeball 5 to form the reflected light ray S2, the reflected light ray S2 enters a photosensitive surface of the image collection module, and the image collection module collects the position of the light ray spot in the eye and the position of the pupil, and performs photographing to obtain an eye image with the light spot; when the eyeball rotates, a relative position relationship between the pupil center and the light spot changes correspondingly, and several eye images with light spots collected by the image collection module reflect a corresponding position change relationship, and line-of-sight/gaze point estimation may be performed according to the position change relationship, so as to complete iris imaging and eyeball tracking.

In summary, the eyeball tracking optical system provided in the present disclosure includes the light source module, the eyepiece module, the first optical path adjustment module and the image collection module; the light source module is located on the edge of the side of the eyepiece module that is close to the user eyeball, thereby reducing the axial horizontal included angle of the photosensitive surface of the camera; the light source module is configured to emit the light ray of the preset wavelength to the user eyeball; the light ray of the preset wavelength is reflected by the user eyeball to form the reflected light ray; the eyepiece module and the first optical path adjustment module are sequentially located on the side away from the user eyeball, and a camera module is moved from the edge of the side of the eyepiece module that is close to the user eyeball to the edge of the side of the eyepiece module that is away from the user eyeball, so that the camera module is disposed inside the system; the reflected light ray at least passes through the eyepiece module and then enters the image collection module, so as to reduce the axial horizontal included angle of the camera and to increase the incident field angle of the light ray; and the image collection module is configured to generate the image of the user eyeball according to the received reflected light ray. Therefore, by using the structural settings, the algorithm precision of image collection and the image quality of the camera can be improved; and the position of the camera may also be saved, and the volume of the eyeball tracking optical system is further compressed, thereby meeting the structural design requirements of the eyeball tracking and iris recognition technology of the compact display optical machine.

As a feasible implementation, with continued reference to FIG. 2, optionally, the photosensitive surface of the image collection module 4 faces the user eyeball 5, and the reflected light ray S2 passes through the eyepiece module 2 and then enters the image collection module 4.

Specifically, the image collection module 4 is moved from the edge of the side of the eyepiece module 2 that is close to the user eyeball 5 to the edge of the side of the eyepiece module 2 that is away from the user eyeball 5, and the photosensitive surface of the image collection module 4 faces the user eyeball 5, at this time, the axial horizontal included angle of the photosensitive surface of the camera is b, and b<a, so that the axial horizontal included angle of the photosensitive surface of the camera is reduced; the reflected light ray S2 passes through the eyepiece module 2 and then enters the image collection module 4, so that the photosensitive surface of the image collection module 4 receives the reflected light ray S2 reflected by the user eyeball 5 as much as possible, therefore the light reception rate of the image collection module 4 can be improved, and the image imaging brightness is increased.

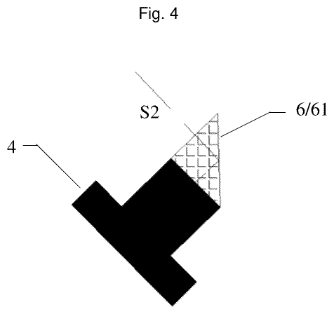

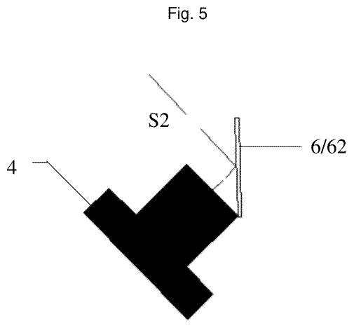

FIG. 4 is a schematic structural diagram of a dimming module and an image collection module provided in the present disclosure; and FIG. 5 is a schematic structural diagram of another dimming module and another image collection module provided in the present disclosure. As a feasible implementation, as shown in FIG. 3 to FIG. 5, optionally, the eyeball tracking optical system further includes a dimming module 6; the dimming module 6 and the image collection module 4 are fixedly disposed; the dimming module 6 is configured to adjust the propagation direction of the reflected light ray S2; and the reflected light ray S2 passes through the eyepiece module 2 and then enters the image collection module 4 after being reflected by the dimming module 6.

Specifically, the dimming module 6 may also be fixedly disposed on a front end of the photosensitive surface of the image collection module 4, and the dimming module 6 may reflect the light ray of the preset wavelength emitted from the light source module 1, so that the propagation direction of the reflected light ray S2 can be adjusted; as shown in FIG. 4 and FIG. 5, a built-in photographing mode of the photosensitive surface of the image collection module 4 is realized, that is, the photosensitive surface no longer faces the user eyeball 5, at this time, the axial horizontal included angle of the photosensitive surface of the camera is c, and c<α, so that the axial horizontal included angle of the photosensitive surface of the camera is reduced, and the incident field angle of the light ray is increased, thereby improving the algorithm precision of image collection and the image quality of the camera.

Optionally, as shown in FIG. 3 and FIG. 4, the dimming module 6 includes a reflective prism 61, and the reflected light ray S2 is reflected by a reflective surface of the reflective prism 61 and then enters the image collection module 4.

Specifically, the reflective prism 61 uses the law of reflection and the law of refraction of light, when the light is reflected in the same medium, reflection angles and incident angles thereof are equal; and when the light is incident from one medium to another medium perpendicular to the interface between two media, refraction will not occur. The reflective prism 61 has a reflective surface; and moreover, by setting an included angle between the reflective surface of the reflective prism 61 and the photosensitive surface of the image collection module 4, it is ensured that more reflected light ray S2 passing through the eyepiece module 2 is reflected by the dimming module 6 and then enters the image collection module 4, and the structure may flexibly adjust the position of the image collection module 4 to further compress the volume of the system, so as to meet the application requirements of eyeball tracking and iris recognition of the compact display optical machine.

Optionally, the reflective surface of the reflective prism includes a reflection-enhancement film. Since the reflection-enhancement film is plated on the reflective surface of the reflective prism, and the reflection-enhancement film includes a full-band reflective film, the reflection efficiency of the reflected light ray is improved, so that more reflected light ray enters the image collection module to improve the imaging brightness of the eyeball.

Based on the above embodiments, with continued reference to FIG. 2 and FIG. 3, optionally, the light source module 1 includes an array infrared band light source, configured to emit light ray of an array infrared band.

Specifically, the array infrared band light source is an array group composed of several infrared light-emitting sources (700 nm-1100 nm or specific bands), and emits light ray of the array infrared band. By using the array infrared band light source, light ray with uniform light spots may be provided, so that the light ray received by the eyes of the user is uniform in energy, and after the light is reflected by the eyes of the user, the imaging on the image collection module 4 is uniform, thereby reducing the problem of a blurred imaging edge.

Based on the above embodiments, with continued reference to FIG. 3 and FIG. 5, optionally, the dimming module 6 includes an infrared cut-off sheet 62, configured to reflect the light ray of the array infrared band emitted from the array infrared band light source to the image collection module 4. The infrared cut-off sheet 62 refers to a lens on which the light ray of the infrared band is reflected and the light ray of other wavelengths passes through, optical films with high and low refractive indexes are alternately plated on optical glass by using the precision optical coating technology to achieve an infrared (700 nm-1100 nm) cut-off optical filter, and by using the infrared cut-off sheet 62, more light ray emitted from the array infrared band light source is reflected to the image collection module 4, thereby improving the utilization rate of the light ray and facilitating to improve the algorithm precision of image collection and the image quality of the camera.

Based on the above embodiments, with continued reference to FIG. 2 and FIG. 3, optionally, the eyeball tracking optical system further includes a display screen 7; and the display screen 7 is located on a side of the eyeball tracking optical system that is away from the user eyeball 5, and the display screen 7 is a multi-dimensional display screen, configured to display a multi-dimensional image.

Specifically, the display screen 7 may be an organic light emitting diode display (OLED) display screen, a light emitting diode display (LED) display screen, a micro light emitting diode display (Micro LED) display screen, or the like, and displays a colored or black-and-white picture; and the display screen 7 is located on a side of the first optical path adjustment module 3 that is away from the eyes of the user, and the multi-dimensional image emitted from the display screen 7 sequentially passes through the first optical path adjustment module 3 and the eyepiece module 2 and then reaches the eyes of the user for imaging.

Based on the above embodiments, with continued reference to FIG. 2 and FIG. 3, optionally, the eyepiece module 2 includes a first fixed lens, and the first optical path adjustment module 3 includes a second fixed lens 31 and an adjustable lens 32; an optical axis of the first fixed lens, an optical axis of the second fixed lens 31 and an optical axis of the adjustable lens 32 are located on the same straight line L; and the adjustable lens 32 may move in the direction of the straight line L. Specifically, with continued reference to FIG. 2 and FIG. 3, the optical axis of the first fixed lens, the optical axis of the second fixed lens 31 and the optical axis of the adjustable lens 32 are located on the same straight line L, the adjustable lens 32 is a lens close to one side of the display screen 7 and may move in the direction of the straight line L of the optical axis, the adjustable lens 32 is located on a lens in the compact display optical machine that is close to a screen, an effect of adapting to different refractive power is achieved by adjusting the distances of the adjustable lens relative to the second fixed lens 31 and the display screen 7, so as to meet the wearing requirements of users with different eye visions, so that the users can clearly see the multi-dimensional picture on the display screen.

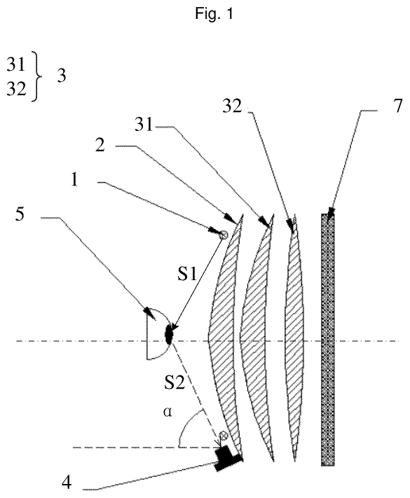

It should be noted that, for other reference signs in FIG. 1, reference may be made to FIG. 2 and FIG. 3, and thus details are not described herein again.

In summary, the eyeball tracking optical system provided in the present disclosure solves the problem of the axial horizontal included angle of the camera becoming greater by changing the position layout of the camera and increasing optical devices, so that the axial horizontal included angle of the camera can be reduced, the utilization rate of the light ray is increased, and the algorithm precision of image collection and the image quality of the camera are improved; and by changing the camera to the built-in photographing mode, the eyeball tracking optical system may be further compressed, thereby meeting the structural design requirements of the eyeball tracking and iris recognition technology of the compact display optical machine.

Based on the same inventive concept, the present disclosure provides a head-mounted device, including a head-mounted apparatus and the eyeball tracking optical system provided in the above embodiments, which may be configured in a user-wearable eyeball tracking and iris recognition application.

It should be noted that the above descriptions are only preferred embodiments of the present disclosure and technical principles applied. Those skilled in the art will understand that the present disclosure is not limited to the specific embodiments described herein, and various obvious changes, readjustments, mutual combinations and substitutions may be made by those skilled in the art without departing from the protection scope of the present disclosure. Therefore, although the present disclosure has been described in detail by the above embodiments, the present disclosure is not only limited to the above embodiments, but may also include more other equivalent embodiments without departing from the concept of the present disclosure, and the scope of the present disclosure is determined by the scope of the appended claims.

1. An eyeball tracking optical system, comprising a light source module, an eyepiece module, a first optical path adjustment module and an image collection module, wherein
the light source module is located on an edge of a side, close to a user eyeball, of the eyepiece module, and the light source module is configured to emit a light ray of a preset wavelength to the user eyeball; the light ray of the preset wavelength is reflected by the user eyeball to form a reflected light ray;
the eyepiece module and the first optical path adjustment module are sequentially located on a side away from the user eyeball, and the image collection module is located on an edge of a side of a gap between the eyepiece module and the first optical path adjustment module; and
the reflected light ray at least passes through the eyepiece module and then enters the image collection module, and the image collection module is configured to generate an image of the user eyeball.

2. The eyeball tracking optical system according to claim 1, wherein a photosensitive surface of the image collection module faces the user eyeball, and the reflected light ray passes through the eyepiece module and then enters the image collection module.

3. The eyeball tracking optical system according to claim 1, further comprising a dimming module, wherein the dimming module and the image collection module are fixedly disposed; and
the dimming module is configured to adjust a propagation direction of the reflected light ray; and the reflected light ray passes through the eyepiece module and then enters the image collection module after being reflected by the dimming module.

4. The eyeball tracking optical system according to claim 2, wherein the dimming module comprises a reflective prism, and
the reflected light ray is reflected by a reflective surface of the reflective prism and then enters the image collection module.

5. The eyeball tracking optical system according to claim 4, wherein the reflective surface of the reflective prism comprises a reflection-enhancement film; and
the reflection-enhancement film is configured to improve a reflection efficiency of the reflected light ray.

6. The eyeball tracking optical system according to claim 2, wherein the light source module comprises an array infrared band light source, configured to emit a light ray of an array infrared band.

7. The eyeball tracking optical system according to claim 6, wherein the dimming module comprises an infrared cut-off sheet, configured to reflect the light ray of the array infrared band emitted from the array infrared band light source to the image collection module.

8. The eyeball tracking optical system according to claim 1, wherein the eyepiece module comprises a first fixed lens, and the first optical path adjustment module comprises a second fixed lens and an adjustable lens; and
an optical axis of the first fixed lens, an optical axis of the second fixed lens and an optical axis of the adjustable lens are located on a same straight line; and the adjustable lens is able to move in a direction of the straight line.

9. The eyeball tracking optical system according to claim 1, further comprising a display screen, wherein the display screen is located on a side, away from the user eyeball, of the first optical path adjustment module, and the display screen is a multi-dimensional display screen, configured to display a multi-dimensional image.

10. A head-mounted device, comprising a head-mounted apparatus and the eyeball tracking optical system according to claim 1.

11. The head-mounted device according to claim 10, wherein a photosensitive surface of the image collection module faces the user eyeball, and the reflected light ray passes through the eyepiece module and then enters the image collection module.

12. The head-mounted device according to claim 10, further comprising a dimming module, wherein the dimming module and the image collection module are fixedly disposed; and
the dimming module is configured to adjust a propagation direction of the reflected light ray; and the reflected light ray passes through the eyepiece module and then enters the image collection module after being reflected by the dimming module.

13. The head-mounted device according to claim 11, wherein the dimming module comprises a reflective prism, and
the reflected light ray is reflected by a reflective surface of the reflective prism and then enters the image collection module.

14. The head-mounted device according to claim 13, wherein the reflective surface of the reflective prism comprises a reflection-enhancement film; and
the reflection-enhancement film is configured to improve a reflection efficiency of the reflected light ray.

15. The head-mounted device according to claim 11, wherein the light source module comprises an array infrared band light source, configured to emit a light ray of an array infrared band.

16. The head-mounted device according to claim 15, wherein the dimming module comprises an infrared cut-off sheet, configured to reflect the light ray of the array infrared band emitted from the array infrared band light source to the image collection module.

17. The head-mounted device according to claim 10, wherein the eyepiece module comprises a first fixed lens, and the first optical path adjustment module comprises a second fixed lens and an adjustable lens; and
an optical axis of the first fixed lens, an optical axis of the second fixed lens and an optical axis of the adjustable lens are located on a same straight line; and the adjustable lens is able to move in a direction of the straight line.

18. The head-mounted device according to claim 10, further comprising a display screen, wherein
the display screen is located on a side, away from the user eyeball, of the first optical path adjustment module, and the display screen is a multi-dimensional display screen, configured to display a multi-dimensional image.
